(19) United States
(12) Patent Application Publication
(10) Pub. No.: US 2023/0403142 A1
(43) Pub. Date: Dec. 14, 2023

(54) ULTRA-WIDEBAND SESSION KEY SHARING SCHEME

(71) Applicant: Apple Inc., Cupertino, CA (US)

(72) Inventor: Ryuji Ishiguro, San Francisco, CA (US)

(73) Assignee: Apple Inc., Cupertino, CA (US)

(21) Appl. No.: 17/878,483

(22) Filed: Aug. 1, 2022

Related U.S. Application Data
(60) Provisional application No. 63/351,758, filed on Jun. 13, 2022.

(51) Int. Cl. H04L 9/08; H04L 9/40

(52) U.S. Cl. CPC H04L 9/085; H04L 9/0866; H04L 63/0435

(57) ABSTRACT

Aspects of the disclosure include a shared session key generation scheme. A method for a shared session key generation scheme includes retrieving, by a first device, a public key of a second device. The first device can generate a first session key, based at least in part on the public key of the second device and a private key of the first device. The first device can establish a secure session with the second device based at least in part on generating the first session key. The first device can receive a message from the second device via the secure session, the message being encrypted by a second session key generated by the second computing device, the first session key being a duplicate of the second session key. The first device can decrypt the message using the first session key

### CROSS-REFERENCES TO RELATED APPLICATIONS

This application claims the benefit of prior filed U.S. Provisional Patent Application No. 6/351,758, filed Jun. 13, 2022, which is hereby incorporated by reference herein in its entirety.

### BACKGROUND

Location-based services are increasingly adopting ultra-wideband (UWB) technology for ranging and positioning-based services and implementing this technology in consumer products. The proliferation of UWB technology has created multiple uses for devices equipped with UWB chips. In addition to uses, security threats to the devices have grown proportionally to the number of UWB-enabled devices.

### BRIEF DESCRIPTION OF THE DRAWINGS

FIG. 1 is an illustration of a shared session key system, in accordance with some embodiments.

FIG. 2 is a signaling diagram for a key sharing scheme of an ultra-wideband (UWB) communication, in accordance with some embodiments.

FIG. 3 is a signaling diagram for a key sharing scheme of an ultra-wideband (UWB) communication, in accordance with some embodiments.

FIG. 4 is a signaling diagram for a key sharing scheme of an ultra-wideband (UWB) communication, in accordance with some embodiments.

FIG. 5 is a signaling diagram for a key sharing scheme of an ultra-wideband (UWB) communication, in accordance with some embodiments.

FIG. 6 is a signaling diagram for a key sharing scheme of an ultra-wideband (UWB) communication, in accordance with some embodiments.

FIG. 7 is a process flow for a key sharing scheme of an ultra-wideband (UWB) communication, in accordance with some embodiments.

FIG. 8 is a process flow for a key sharing scheme of an ultra-wideband (UWB) communication, in accordance with some embodiments.

FIG. 9 is a process flow for a key sharing scheme of an ultra-wideband (UWB) communication, in accordance with some embodiments.

### DETAILED DESCRIPTION

In the following description, various examples will be described. For the purposes of explanation, specific configurations and details are set forth to provide a thorough understanding of the examples. However, it will also be apparent to one skilled in the art that the examples may be practiced without the specific details. Furthermore, well-known features may be omitted or simplified in order not to obscure the example being described.

Ultra-wideband (UWB) relates to radio communications that use a bandwidth that can be close to or greater than 500 MHz. UWB technology can be favorable for certain communications because it allows for a high channel capacity, reduction of interference of multi-path influences, and a high temporal resolution for precise timing.

The FiRa consortium (FiRa) is an organization that releases technical standards for a UWB physical layer (PHY) and medium access control layer (MAC). The FiRa technical standards build on the Institute of Electrical and Electronics Engineers (IEEE) 802.15.4 and 802.15.4z standards, which relate to the PHY and MAC of a low-rate wireless personal area network (LR-WPAN).

FiRa releases standards related to strengthening secure communications for the ranging and positioning capabilities of UWB technology. One security concern for wireless communications can be a situation in which a device intercepts (e.g., monitors) communication between two other devices. One such particular situation can occur between two devices that are communicating via near short-range transmission protocol. In some situations, the first device can be near the second device. For example, a traveler can use a digital wallet stored on their smartphone to swipe and pay for some coffee. However, a third device can be slightly farther away from the second device than the first device. The third device can further intercept communications between the first and second devices. This can be particularly troublesome if the third device can intercept financial data from either the first device or the second device. Conventional mitigation techniques rely upon multiple round trip signal transmissions between the first device and the second device to establish authentication. Furthermore, the devices may need to sign their transmission with a certificate and verify each other's signatures. Once the devices are authenticated, the devices can communicate over a secure channel. However, multiple round-trip signal transmissions and signature verifications are time-consuming and can be computationally expensive.

Embodiments described herein address the above-described issues by establishing a secret key that can be stored on the first device and the second device for message authentication. The first device can include a near field communication (NFC) tag having a microchip with information that can be read by an NFC reader device in range. The second device can include an NFC reader for reading the NFC tag. The secret key can be separately created on each device within a single round-trip between the two devices. The herein described embodiments can further eliminate the need for a certificate. Certificates require a significant amount of data storage, and therefore eliminating the certificate reduces the storage burden on a device, such as a mobile device.

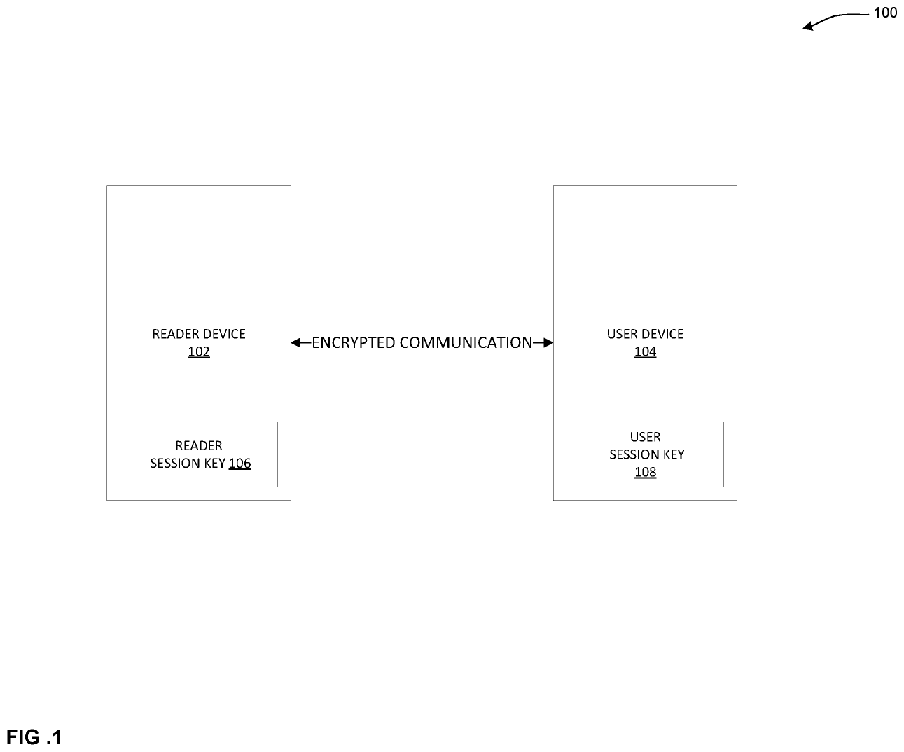

FIG. 1 is an illustration 100 of an encrypted communication over a UWB secure communication channel between a reader device 102 and a user device 104. The reader device 102 can be any device that can securely and wirelessly communicate with the user device 104 over a UWB communication channel. For example, the reader device 102 can be a gate reader at an entrance, a point-of-sale system at a kiosk, or a door lock. The user device 104 can be, for example, a smartphone. As described herein, the reader device 102 and the user device 104 can securely communicate with each other via encryption and decryption of the communications using a shared session key.

As seen in FIG. 1, the reader device 102 includes a reader session key 106, and the user device includes a user session key 108. As described herein, without exchanging session keys, the reader device 102 can create the reader session key 106 that can be the same as the user session key 108, and the user device 104 can create the user session key 108, which is the same as the reader session key 106. In this sense, the reader device 102 can encrypt a communication to the user device 104 using the reader session key 106. The user device 104 can decrypt the communication from the reader device 102 using the user session key 108. Conversely, the user device 104 can encrypt a communication to the reader device 102 using the user session key 108, and the reader device 102 can decrypt the communication using the reader session key 106.

As described above, conventional systems can require multiple round-trip signal transmissions to authenticate another device before communicating via a secure channel. As seen in the embodiments described here, a single round-trip signal transmission can be performed, in which, at the end of the round-trip, both the reader device 102 and the user device 104 can create their own session key, and the reader device 102 verify that the user device 104 created a user session key 108 that is a copy of the reader session key 106. Based on verifying that the user device 104 created a copy, the reader device 102 can initiate a secure session over a UWB channel with the user device 104.

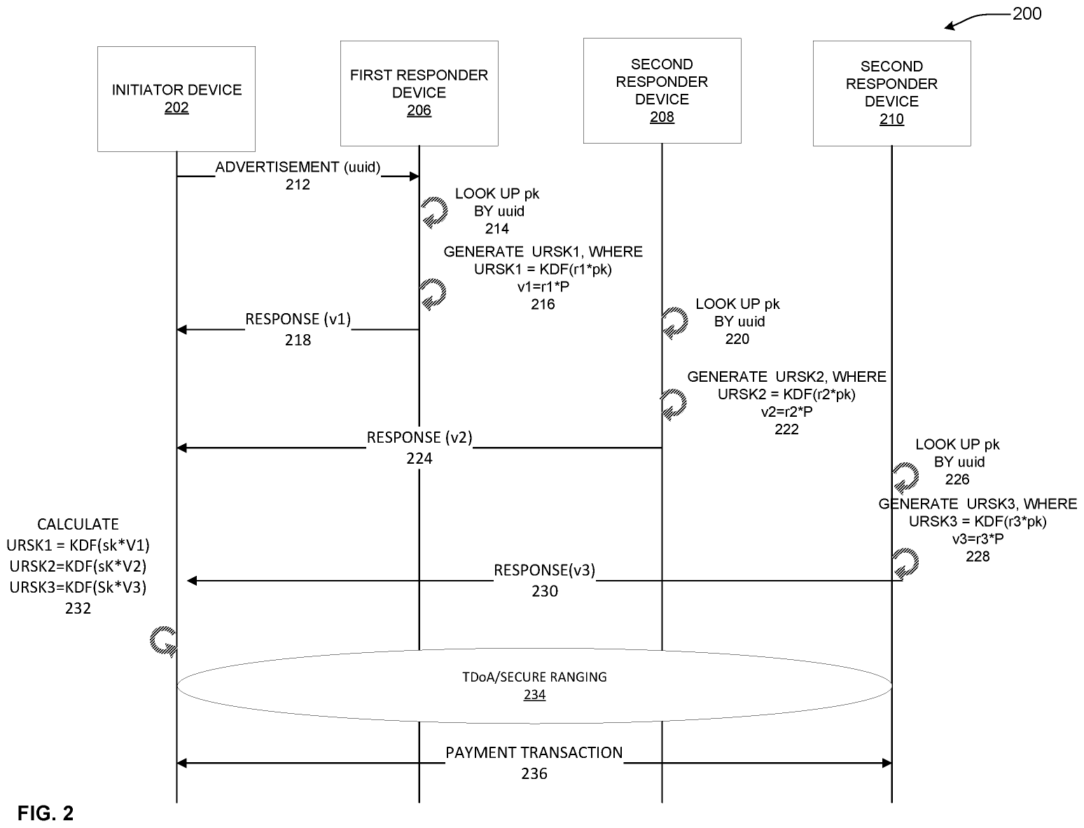

FIG. 2 is a signaling diagram 200 for a session key sharing scheme, in accordance with some embodiments. As illustrated, an initiator device 202 can be in communication with a first responder device 204, a second responder device 206, and a third responder device 208. While the operations of processes 200, 300, 400, 500, 600, 700, 800, and 900 are described as being performed by generic computers, it should be understood that any suitable device (e.g., a reader device, a responder device) may be used to perform one or more operations of these processes. Processes 200, 300, 400, 500, 600, 700, 800, and 900 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 212, the initiator device 202 can advertise an identifier, uuid, of the device. The advertisement can be broadcast such that the advertisement can be received by any device within a threshold range of the initiator device 202. The advertisement can be transmitted over a non-secure channel. In other words, the data transmitted by the initiator device 202 is not encrypted. The advertisement can be received by the first responder device 204, the second responder device 206, and the third responder device 208. The responder devices can be, for example, the smartphones of travelers at the train station. It should be appreciated that the advertisement can be received in any order by responder devices within proximity of the initiator device 202.

At 214, the first responder device 204 can use a lookup function to identify a public key, pk, associated with the initiator device 202 based on receiving the advertisement. The lookup function can look up the pk corresponding to the uuid in a database. The database can include a set of uuids and corresponding pks. The responder devices can be configured to all have access to the same uuid/pk database.

At 216, the first responder device 204 can generate a first session key, URSK1. URSK1 can be a symmetric key to be shared by the initiator device 202 and the first responder device 204 for message authentication. As described throughout this application, a same session key can be locally generated by an initiator device and a responder device. As the session key is a symmetric key, it can be used for both encryption and decryption of a message. Therefore, both the initiator device, and the responder device can encrypt and decrypt messages between each other using their own locally generated session key.

URSK1 can be generated by applying a key derivation function (e.g., a hash function), KDF, to a first random number, r1 and pk (e.g., URSK1=KDF(r1*pk). The r1 can be generated by the first responder device 204 in response to receiving the uuid. The KDF can be a cryptographic algorithm for generating one or more session keys using a main key, such as a public key. The first responder device 204 can further store URSK1, such that a communication from the initiator device 202 that is encrypted using URSK1 can be decrypted by the first responder device 204 using URSK1. In some embodiments, URSK1 can be a 128-bit session key.

The first responder device 204 can further generate a first value, v1, based on r1 and a public parameter, P (e.g., v1=r1*P). In some instances, P can be defined by a point on an elliptic curve, as used in a Diffie-Hellman key exchange and sometimes be referred to as the base point. In some embodiments, pk can be generated based on a private key, sk, of the initiator device 202 and P (e.g., pk=sk*P).

At 218, the first responder device 204 can transmit a response including v1 to the initiator device 202. As r1 and P be limited in size, the response can, by design, be limited in size. For example, the response can have a maximum size of 64 bytes. This reduces the payload from the first responder device 204 to the initiator device 202.

At 220, the second responder device 206 can use a lookup function to identify pk based on receiving the advertisement from the initiator device 202.

At 222, the second responder device 206 can generate a second session key, URSK2. URSK2 can be generated by applying a KDF to a second random number, r2 and pk (e.g., URSK2=KDF(r2*pk). The r2 can be generated by the second responder device 206 in response to receiving the uuid. The second responder device 206 can further store URSK2 to enable decryption and encryption of future communications with the initiator device 202.

The second responder device 206 can further generate a second value, v2, based on r2 and P (e.g., v2=r2*P). At 224, the second responder device 206 can transmit v2 to the initiator device 202.

At 226, the third responder device 208 can perform a lookup to identify pk based on receiving the advertisement from the initiator device 202.

At 228, the third responder device 208 can generate a third session key. URSK3 can be generated by applying a KDF to a third random number, r3 and pk (e.g., URSK3=KDF(r3*pk). The r3 can be generated by the third responder device 208 in response to receiving the uuid. The third responder device 208 can further store URSK3 to enable decryption and encryption of future communications with the initiator device 202.

The third responder device 208 can further generate a third value, v3, based on r3 and P (e.g., v3=r3*P). At 230, the third responder device 208 can transmit v3 to the initiator device 202.

At 232, the initiator device 202 can calculate URSK1 by applying the KDF to sk and v1 (e.g., URSK1=KDF(sk*v1)). The initiator device 202 can calculate URSK2 by applying the KDF to sk and v2 (e.g., URSK2=KDF(sk*v2)). The initiator device 202 can even further calculate URSK3 by applying the KDF to sk and v3 (e.g., URSK3=KDF(sk*v3)). Upon calculation, both the initiator device 202 and each of the responder devices have the identical session keys (URSK1, URSK2, and URSK3). The session keys can be generated over a single round-trip and later used to encrypt and decrypt communications between the initiator device 202 and the respective responder devices. The initiator device 202 can further anchor communications with each responder device with their respective session key. Furthermore, based on the encryptions, neither the transmitting device, nor the receiving devices need to verify a signature to authenticate the communication.

It should be appreciated that, as illustrated, the initiator device 202 generates all three session keys after the third responder device 208 has transmitted v3 at step 230. It can be conceivable that the initiator device 202 generates a session key without waiting for receipt of another session key. For example, the initiator device 202 generates URSK1 after receiving v1 in step 218 and before step 220; rather than waiting until step 232.

After both the initiator device 202 and a responder device have shared a session key (e.g., URSK1, URSK2, or URSK3), the devices can initiate a secure session, in which communications are secured via the session keys. For example, at 234, the initiator device 202 and one of the responder devices can initiate a session for positioning using a time data of arrival technique (TDoA), or a secure ranging session. During these sessions, time stamps that are transmitted between the devices can be encrypted using the session key. Without the time stamps, a malicious device cannot perform localization or ranging and therefore cannot glean any useful information by intercepting the data transferred during a session.

At step 236, the initiator device 202 and one of the responder devices can, instead of positioning or ranging, initiate a secure payment transaction. For example, a traveler paying for coffee at a kiosk. A payment transaction relies on identity protection, anti-replay attack protection. As only the initiator device 202 and the corresponding responder device can use the session key to encrypt the communication, a third device cannot read the encrypted communication between the two devices.

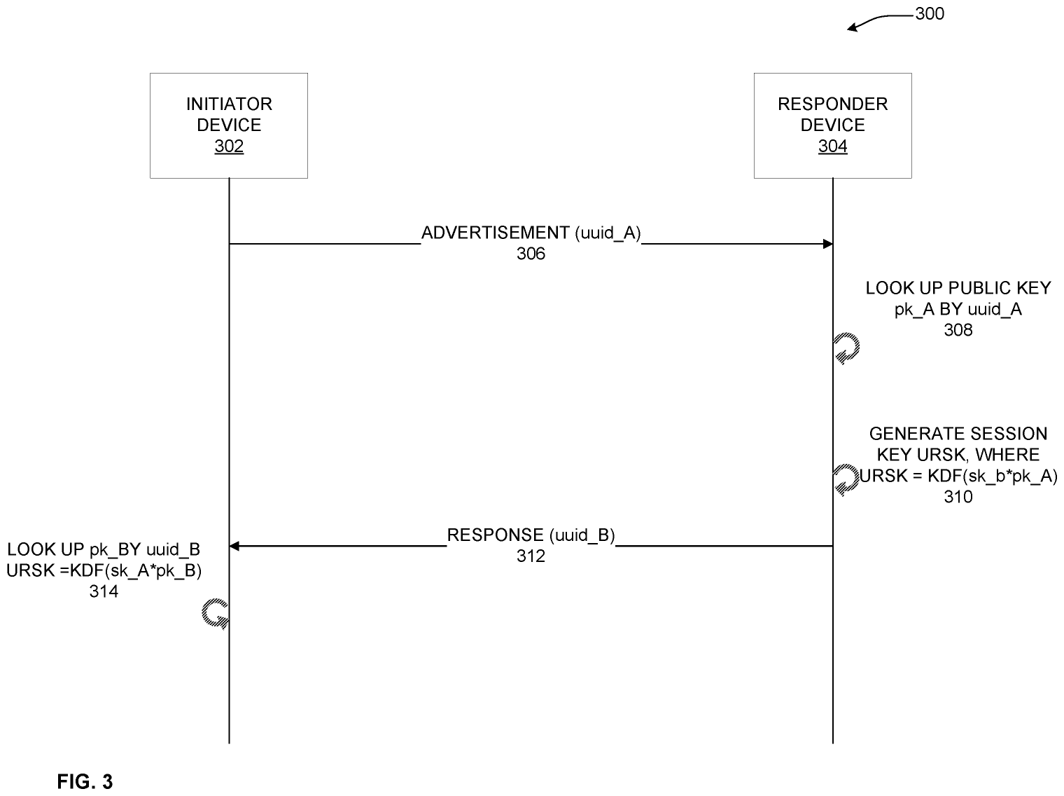

FIG. 3 is a signaling diagram 300 for a unilateral session key sharing scheme, in accordance with some embodiments. As illustrated, an initiator device 302 can be in communication with a responder device 304.

At 306, the initiator device 302 can advertise its identifier (uuid_A), which can be received by the responder device 304.

At 308, the responder device 304 can use a lookup function to find a public key, pk_A, associated with the uuid_A. For example, the responder device 304, via the lookup function can have access to a database of uuids of initiator devices and their associated pks. The lookup function can retrieve the pk from the database for the responder device 304.

At 310 the responder device 304 can generate a session key, URSK. URSK can be generated by the responder device 304 based on using a KDF on a private key, sk_b associated with the responder device 304 and pk_A (e.g., URSK=KDF(sk_B*pk_A).

At 312, the responder device 304 can transmit a response including a uuid_B. The uuid_B can be limited in byte size to limit the payload size of the response. For example, the payload, including the uuid_B can be sixteen bytes. Alternatively, to sending the uuid_B, the responder device 304 can transmit a certificate to the initiator device 302.

At 314, in response to receiving the response from the responder device 304, the initiator device 302 can use a lookup function to find a public key, pk_B, associated with the responder device 304. For example, the initiator device 302 can, via the lookup function, have access to a database that includes public keys and associated uuids. The lookup function can retrieve pk_B for the initiator device 302. In the case that the responder device 304 transmits a certificate, the lookup function can search for pk_B using the certificate.

The initiator device 302 can generate URSK separately from the responder device's generation of URSK. The initiator device 302 can generate URSK by applying a KDF to sk_A and pk_B (e.g., URSK=KDF(sk_A*pk_B).

Once both the initiator device 302 and the responder device 304 have URSK, they can securely communicate by encrypting and decrypting their messages using URSK.

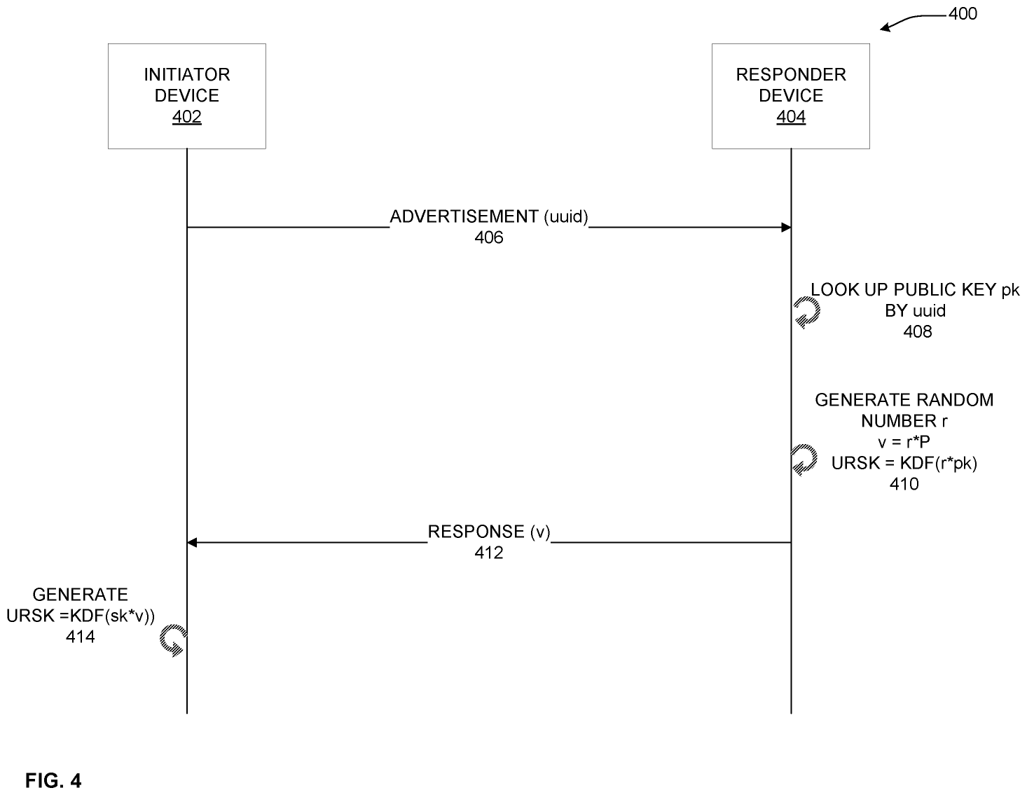

FIG. 4 is a signaling diagram 400 for a session key sharing scheme, in accordance with some embodiments. As illustrated, an initiator device 402 can be in communication with a responder device 404.

At 406, the initiator device 402 can advertise its identifier (uuid), which can be received by the responder device 404.

At 408, the responder device 404 can use a lookup function to find a public key, pk, associated with the uuid. For example, the responder device 404, via the lookup function can have access to a database of uuids of initiator devices and their associated pks. The lookup function can retrieve the pk from the database.

At 410 the responder device 404 can generate a session key, URSK. The responder device 404 can generate a random number, r. The responder device 404 can generate a value, v, based on r and P. The URSK can be generated by the responder device 404 based on using a KDF on r and pk, (e.g., URSK=KDF(r*pk).

At 412, the responder device 404 can transmit a response including v. The response payload can be limited to 64 bytes.

At 414, in response to receiving the response from the responder device 404, the initiator device 402 can generate URSK separately from the responder device's generation of URSK. The initiator device 402 can generate URSK by applying a KDF to sk and V (e.g., URSK=KDF(sk*V)).

Once both the initiator device 402 and the responder device 404 have URSK, they can securely communicate by encrypting and decrypting their messages using URSK.

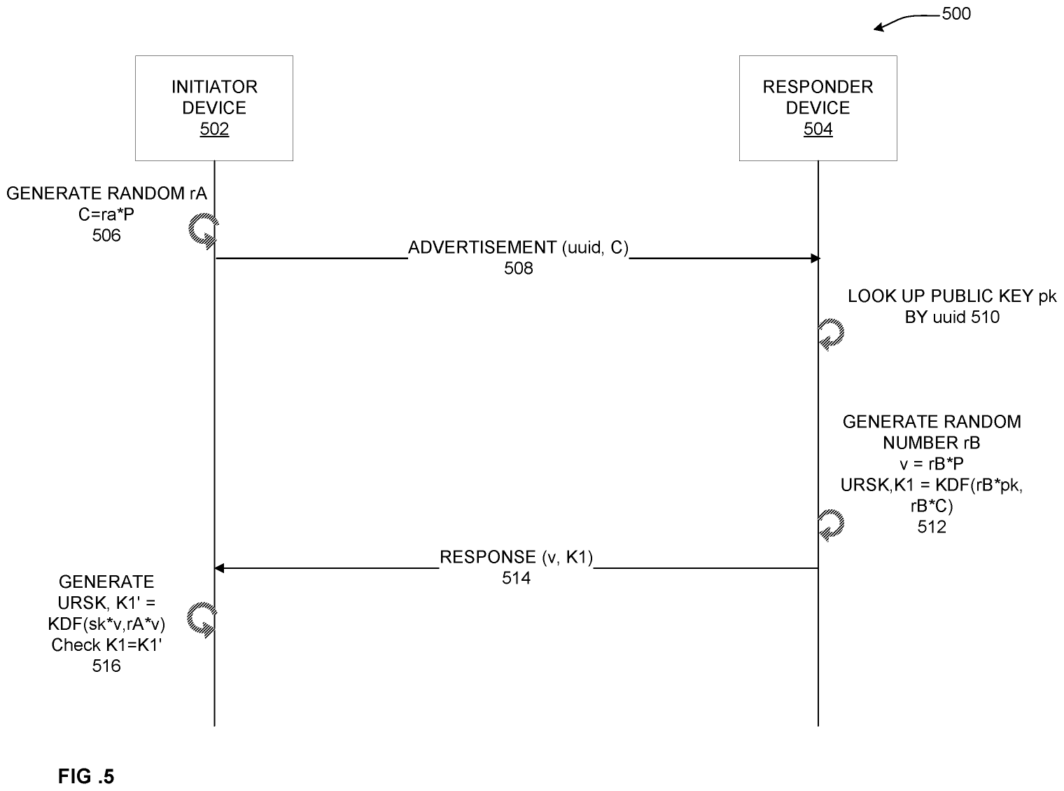

FIG. 5 is a signaling diagram 500 illustrating a forward secrecy session key sharing scheme. As illustrated, an initiator device 502 and a responder device 504 are in communication.

At 506, the initiator device 502 can generate a public key, C. The initiator device 502 can generate C by generating a random number, rA. The initiator device 502 can then generate C based on rA and a public parameter, P (e.g., C=rA*P). It should be appreciated that in the herein described embodiment, both the initiator device and responder device are preconfigured to store P.

At 508 the initiator device 502 can advertise its identifier, uuid, and C; which the responder device 504 can receive.

At 510, the responder device 504 can use a lookup function to find a public key, pk, associated with the uuid. For example, the responder device 504, via the lookup function can have access to a database of uuids of initiator devices and their associated pks. The lookup function can retrieve the pk from the database.

At 512, the responder device 504 can a session key, URSK, and a key value K1. The responder device 504 can generate a random number, rB. The responder device 504 can then generate a value, v, based on rB and P (e.g., v=rB*P). The responder device can then generate URSK be applying a KDF to rB and pk (e.g., URSK=KDF(rB*pk). The responder device 504 can generate K1 by applying the KDF to rB and C (e.g., K1=KDF(rB*C).

At 514, the responder device 504 can transmit a response including v and K1 to the initiator device 502. K1 can be optional in instances that the initiator device 502 and the responder device 504 implement a full Perfect Forward Secrecy (PFS) encryption technique. The response payload can be limited to 80 bytes.

At 516, the initiator device 502 can generate URSK separately from the responder device 504. The initiator device 502 can further generate a reference key value K1′. The initiator device 502 can generate URSK by applying the KDF to the convolution of its private key, sk, and v (e.g., URSK=sk*v). The initiator device can generate K1′ by applying the KDF to the convolution of rA and v (e.g., URSK=rA*v). The initiator device 502 can verify URSK by determining whether K1 equals K1′. If K1 equals K1′, URSK can be verified, and the initiator device 502 can open a secure session with the responder device 504. If K1 does not K1′, URSK is not verified, and the initiator device 502 does not open a secure session with the responder device 504.

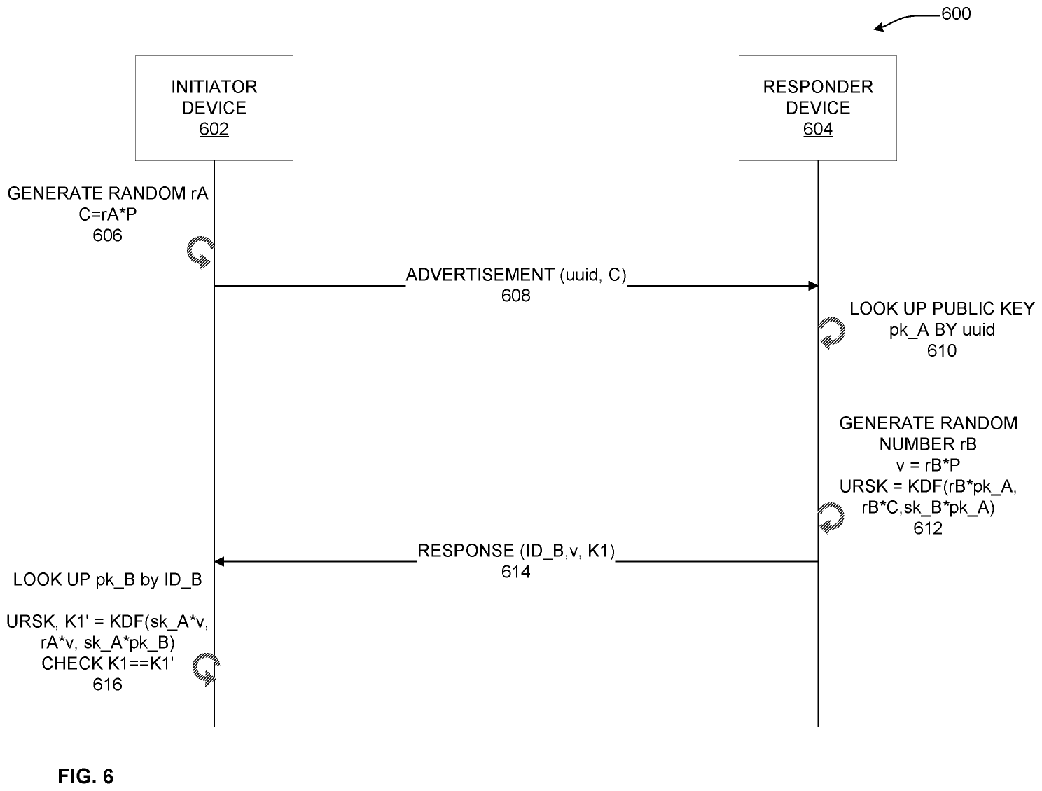

FIG. 6 is a signaling diagram 600 for a non-repudiation key sharing scheme, in accordance with some embodiments. As illustrated, an initiator device 602 can be in communication with a responder device 604.

At 606, the initiator device 602 can generate a public key, C. The initiator device 602 can generate a random number, rA. The initiator device 602 can generate C based on rA and a public parameter, P (e.g., C=rA*P).

At 608, the initiator device 602 can advertise its identifier, uuid and C, which the responder device 604 can receive.

At 610, the responder device 604 can use a lookup function to find a second public key pk_A associated with the uuid. For example, the responder device 604, via the lookup function can have access to a database of uuids of initiator devices and their associated pks. The lookup function can retrieve the pk_A from the database for the responder device 604.

At 612, the responder device 604 can generate a session key, URSK. The responder device can generate a random number rB. The responder device 604 can then generate a value, v, based on rB and P (e.g., v=rb*P). The responder device 604 can then generate URSK and a key value K1. The responder device 604 can generate USRK and K1 by applying a KDF to rB and pk_A, rB and C, and B and pk_A (e.g., URSK=KDF(rB*pk_A, rB*C, sk_B*pk_A).

At 616, the initiator device 602 can use a lookup function to find a public key, pk_B, associated with it by using an identifier ID B. The initiator device 602 can then generate a reference key value, K1′. The initiator device 602 can generate K1′ by applying KDF sk_A and v, rA and v, and sk_A and pk_B (e.g., URSK=KDF(sk_A*v, rA*v, sk_A*pk_B). The initiator device 602 can then verify the URSK by comparing K1 to K1′ (e.g., K1==K1′). If K1 equals K1′, URSK can be verified and the initiator device 602 can open a secure session with the responder device 604. If K1 does not K1′, URSK is not verified, the initiator device 602 does not open a secure session with the responder device 604.

Enforcing key revocations for an individual responder device or initiator device can be unrealistic in some use cases. Without a workable revocation scheme, having individual public key pairs may not be practicable. Therefore, embodiments herein describe a key renewal scheme. Assume that all the initiator devices share the same private key, public key pair (sk[n]/pk[n]) in the embodiments described by FIG. 3. To accomplish this, the service provider can generate several key pairs and configures an initiator device to store the first private key sk[1], and all of the public keys pk[1], . . . , pk [n]. The sk[1] can be identified by a key identifier, KID. After a period of time, the service provider can configure the initiator device to store the next private key, sk[2]. The service operator can further configure the initiator device to store a new KID to identify sk[2].

Embodiments described herein further include a key rachet scheme to prevent rollbacks. That is, once a new private key, sk[2], is installed, the old private key, sk[1], should be invalidated. In the practical situation, it can be unrealistic to install the new key to all initiating devices at once. The system needs a grace period until all readers include the new private key. During such a grace period, the initiating devices can use either the old private key or the new private key. Once the grace period has ended, the service operator can configure the initiator devices to use the new private key and invalidate the old private key.

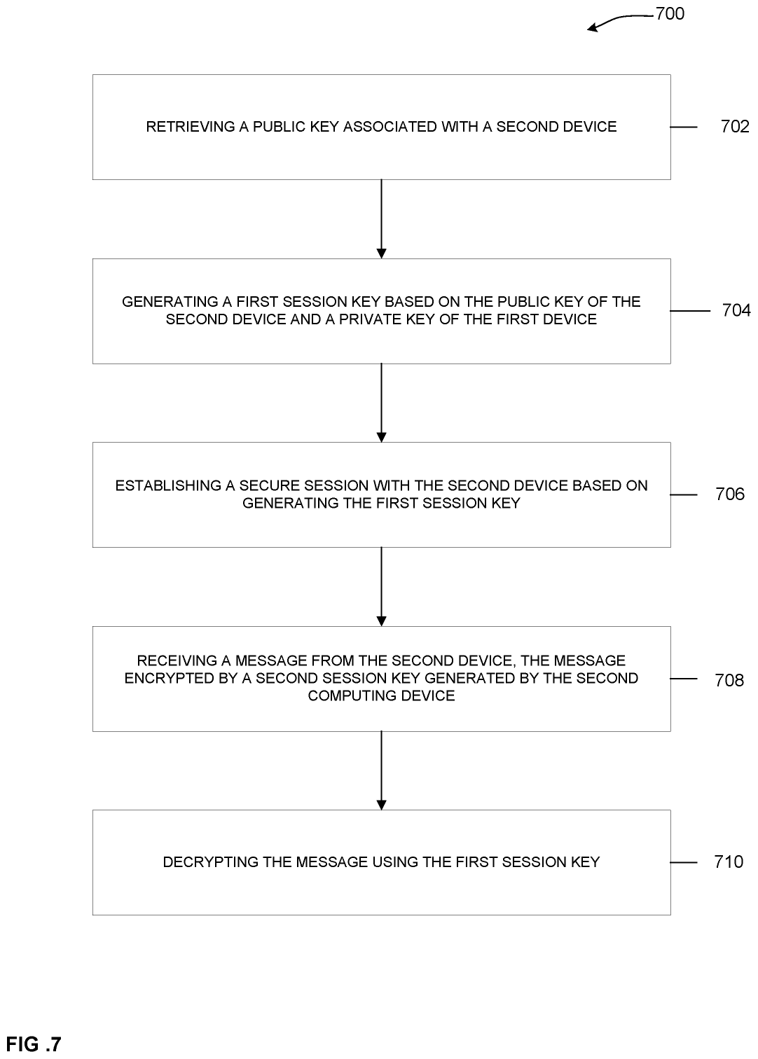

FIG. 7 is a flow diagram 700 for generating a session key, according to some embodiments. At 702, a first device, can retrieve a public key associated with a second device. For example, the first device can receive a uuid associated with the second device, such as a smartphone. The first device can use a lookup function to retrieve the public key from a database based on the uuid.

At 704, the first device can generate a first session based on the public key of the second device and a private key of the first device. For example, the first device can implement a KDF on the public key and private key to generate the session key.

At 706, the first device can establish a secure session with the second device based on generating the first session key. The secure session can be, for example, for a ranging or a positioning purpose.

At 708, the first device can receive a message via the secure session. The message can further be encrypted by the second device using a second session key. The second session key can be a duplicate of the first session and be generated by the second device independently of the first device.

At 710, the first device can decrypt the message using the first session key. The first session key and the second session key are symmetric keys, such that each can be used to decrypt a message encrypted using the other key.

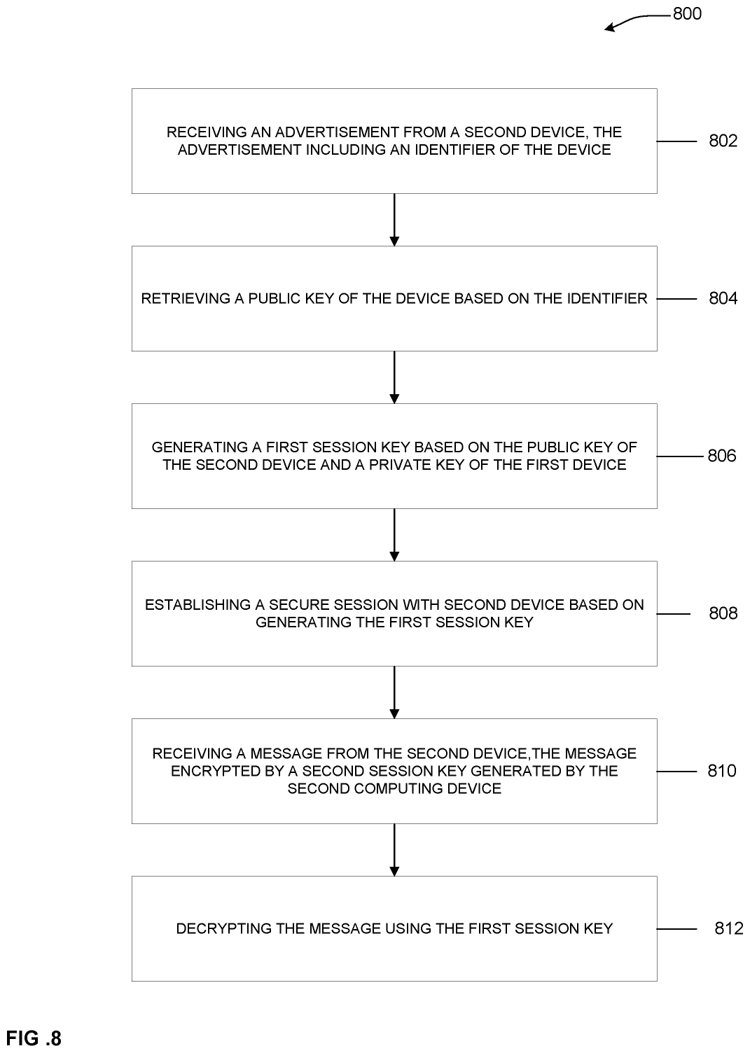

FIG. 8 is a flow diagram 800 for generating a session key, according to some embodiments. At 802, a first device can receive an advertisement from a second device. The advertisement can include an identifier.

At 804, the first device can retrieve a public key associated with a second device. For example, the first device can receive a uuid associated with the second device, such as a smartphone. The first device can use a lookup function to retrieve the public key from a database based on the uuid.

At 806, the first device can generate a first session based on the public key of the second device and a private key of the first device. For example, the first device can implement a KDF on the public key and private key to generate the session key.

At 808, the first device can establish a secure session with the second device based on generating the first session key. The secure session can be, for example, for a ranging or a positioning purpose.

At 810, the first device can receive a message over the secure session from the second device. The message can further be encrypted by the second device using a second session key. The second session key can be a duplicate of the first session and be generated by the second device independently of the first device.

At 812, the first device can decrypt the message using the first session key. The first session key and the second session key are symmetric keys, such that each can be used to decrypt a message encrypted using the other key.

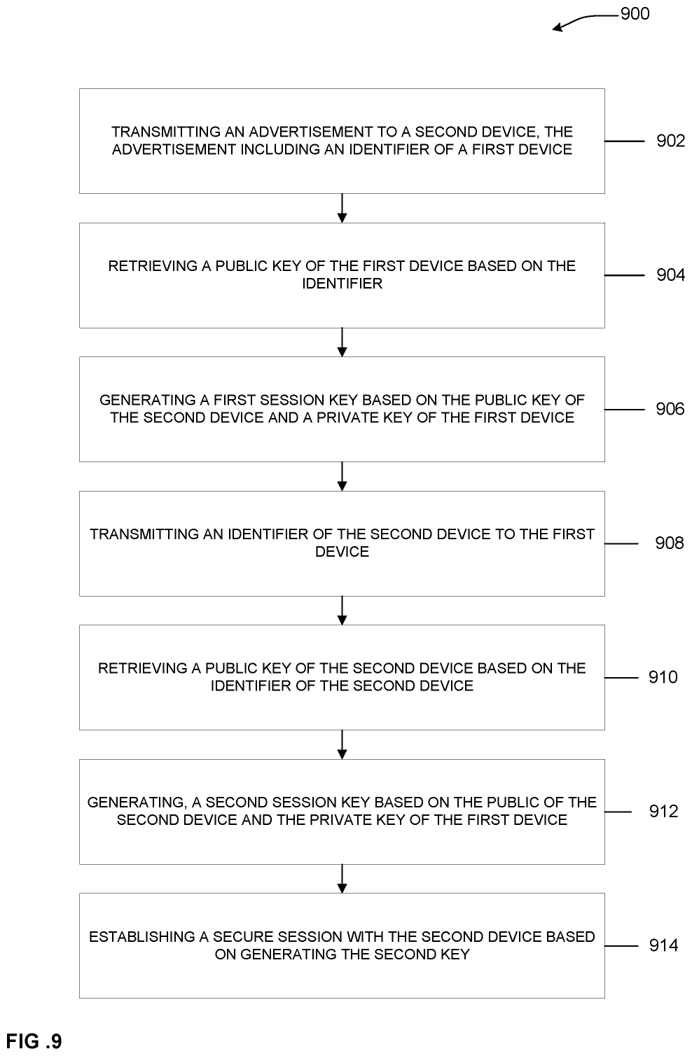

FIG. 9 is a process flow 900 for generating a session key, according to some embodiments. At 902, a first device can transmit an advertisement to a second device. The advertisement can include an identifier of the first device.

At 904, the second device can retrieve a public key of the first device based on the identifier. For example, the second device can use a lookup function to retrieve the identifier from a database.

At 906, the second device can generate a first session key based on the public key of the second device and a private key of the first device.

At 908, the second device can transmit an identifier of the second device to the first device.

At 910, the first device can retrieve a public key of the second device based on the identifier of the second device. For example, the first device can use a lookup function to retrieve the identifier from a database.

At 912, the first device can generate a second session key based on the private key of the first device and the public key of the second device.

At 914, the first device can establish a secure session with the second device based on the generation of the second session key.

While specific embodiments have been described, one skilled in the art will recognize that numerous modifications are possible. A single controller may use processes described herein to establish pairings with any number of accessories and to selectively communicate with different accessories at different times. Similarly, a single accessory may be controlled by multiple controllers with which it has established pairings. Any function of an accessory may be controlled by modeling the function as a service having one or more characteristics and allowing a controller to interact with (e.g., read, modify, receive updates) the service and/or its characteristics. Accordingly, protocols and communication processes as described herein may be “universal,” meaning that they may be applied in any context with one or more controllers and one or more accessories regardless of accessory function or controller form factor or specific interfaces.

Thus, although specific embodiments have been described, it will be appreciated that embodiments may include all modifications and equivalents within the scope of the following claims.

As described above, one aspect of the present technology is the gathering and use of data available from specific and legitimate sources to improve the delivery of messages from one device to one or more devices. The present disclosure contemplates that in some instances, this gathered data may include personal information data that uniquely identifies or may be used to identify a specific person. Such personal information data may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, may be used to the benefit of users. For example, the personal information data may be used to deliver a command from a user profile on a computing device to one or more computing devices. Further, other uses for personal information data that benefit the user are also contemplated by the present disclosure. For instance, specific states of devices (e.g., medical care related devices, fitness devices, etc.) associated with the user may be transmitted from a device back to the user profile.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities may subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements may be provided to prevent or block access to such personal information data. For example, such as in the case of token generation services, the present technology may be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Illustrative techniques for using a computing device to delegate authority to generate a token from an owner to a sharing platform, and provisioning the token by the sharing platform. Some or all of these techniques may, but need not, be implemented at least partially by as those shown at least in FIGS. 1-9 above. While many of the embodiments are described above with reference to computing devices and user devices, it should be understood that other types of computing devices may be suitable to perform the techniques disclosed herein. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various embodiments further can be implemented in a wide variety of operating environments, which in some cases can include one or more user computers, computing devices or processing devices that can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C #or C++, or any scripting language, such as Perl, Python or TCL, as well as combinations thereof. The server(s) may also include database servers, including without limitation those commercially available from Oracle®, Microsoft®, Sybase®, and IBM®

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium that can be used to store the desired information and that can be accessed by the a system device. Based at least in part on the disclosure and teachings provided herein, a person of ordinary skill in the art will appreciate other ways and/or methods to implement the various embodiments. However, computer-readable storage media does not include transitory media such as carrier waves or the like.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a,” “an,” and “the,” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based at least in part on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method, comprising:
receiving, by a first device, an advertisement from a second device, the advertisement comprising an identifier of the second computing device;
retrieving, by the first device, a public key of the second device based at least in part on the identifier;
generating, by the first device, a first session key based at least in part on the public key of the second device and a private key of the first device;
establishing, by the first device, a secure session with the second device based at least in part on generating the first session key;
receiving, by the first device, a message from the second device via the secure session, the message being encrypted by a second session key generated by the second computing device, the first session key being a duplicate of the second session key; and
decrypting, by the first device, the message using the first session key.

2. The method of claim 1, wherein the advertisement is received over a non-secure channel.

3. The method of claim 1, wherein the first session key is generated based on a hash of the public key of the second device and the private key of the first device.

4. The method of claim 1, wherein the first device comprises a near field communication (NFC) tag and the second device comprises an NFC reader.

5. The method of claim 1, wherein the message comprises a maximum of sixteen bytes.

6. The method of claim 1, wherein the message relates to a ranging technique or a positioning technique.

7. The method of claim 1, wherein the first session key is symmetric with the second session key.

8. A first device, comprising:
a processor; and
a computer-readable medium including instructions that, when executed by the processor, cause the processor to perform operations comprising:
receiving an advertisement from a second device, the advertisement comprising an identifier of the second computing device;
retrieving a public key of the second device based at least in part on the identifier;
generating a first session key based at least in part on the public key of the second device and a private key of the first device;
establishing a secure session with the second device based at least in part on generating the first session key;
receiving a message from the second device via the secure session, the message being encrypted by a second session key generated by the second computing device, the first session key being a duplicate of the second session key; and
decrypting the message using the first session key.

9. The first device of claim 8, wherein the advertisement is received over a non-secure channel.

10. The first device of claim 8, wherein the first session key is generated based on a hash of the public key of the second device and the private key of the first device.

11. The first device of claim 8, wherein the first device comprises a near field communication (NFC) tag and the second device comprises an NFC reader.

12. The first device of claim 8, wherein the message comprises a maximum of sixteen bytes.

13. The first device of claim 8, wherein the message relates to a ranging technique or a positioning technique.

14. The first device of claim 8, wherein the first session key is symmetric with the second session key.

15. A non-transitory computer-readable storage media comprising computer-executable instructions that, when executed by a processor of a first device, cause the processor to perform operations comprising:
receiving an advertisement from a second device, the advertisement comprising an identifier of the second computing device;
retrieving a public key of the second device based at least in part on the identifier;
generating a first session key based at least in part on the public key of the second device and a private key of the first device;
establishing a secure session with the second device based at least in part on generating the first session key;
receiving a message from the second device via the secure session, the message being encrypted by a second session key generated by the second computing device, the first session key being a duplicate of the second session key; and
decrypting the message using the first session key.

16. The non-transitory computer-readable storage media of claim 15, wherein the advertisement is received over a non-secure channel.

17. The non-transitory computer-readable storage media of claim 15, wherein the first session key is generated based on a hash of the public key of the second device and the private key of the first device.

18. The non-transitory computer-readable storage media of claim 15, wherein the first device comprises a near field communication (NFC) tag and the second device comprises an NFC reader.

19. The non-transitory computer-readable storage media of claim 15, wherein the message comprises a maximum of sixteen bytes.

20. The non-transitory computer-readable storage media of claim 15, wherein the message relates to a ranging technique or a positioning technique.
